(19) United States
(12) Patent Application Publication
(10) Pub. No.: US 2012/0261854 A1
(43) Pub. Date: Oct. 18, 2012

(54) BUNDLE OF ROVING YARNS, METHOD OF MANUFACTURING A BUNDLE OF ROVING YARNS AND METHOD FOR MANUFACTURING A WORK PIECE

(76) Inventor: Erik Grove-Nielsen, Roslev (DK)

(21) Appl. No.: 13/447,390

(22) Filed: Apr. 16, 2012

(30) Foreign Application Priority Data
Apr. 18, 2011 (EP) EP11162812

(51) Int. Cl. B29C 70/48; B29C 70/16

(52) U.S. Cl. 264/101; 264/103

(57) ABSTRACT

A method of manufacturing a bundle of roving yarns is described. The method is characterised in assembling a number of roving yarns of longitudinal unidirectional fibres and an additional component in a bundle. For example, at least one resin distribution means or a thermoplastic material may be placed as the additional component in the bundle.

### CROSS REFERENCE TO RELATED APPLICATIONS

This application claims priority of European Patent Office application No. 1162812.9 EP filed Apr. 18, 2011. All of the applications are incorporated by reference herein in their entirety.

### FIELD OF INVENTION

The present invention is related to a method of manufacturing a bundle of roving yarns, to a bundle of roving yarns and to the use of such bundles of roving yarns. It is further related to a method for manufacturing a work piece, for example a wind turbine rotor blade, and to a work piece.

### BACKGROUND OF INVENTION

Fibre reinforced plastic composites are used in a variety of technical products such as cars, wind turbine blades, storage tanks etc. Most products of big size, such as wind turbine blades are manufactured by placing woven glass fabric, delivered on rolls, into one or more moulds. In the common resin injection process known as Vacuum Assisted Resin Transfer Moulding (VARTM), the moulds are closed, and vacuum is applied to the closed mould system. A resin, such as polyester, epoxy, vinyl ester or other, is then injected into the mould cavity, thus filling the space between the fibres in the laminates. In load bearing structures, a unidirectional glass fabric is often used. The glass fibre rovings in the fabric may be stitched together using yarns of polyester or similar material. In a long structure, such as a wind turbine blade, the use multiple layers of unidirectional fibre materials may be used. The weaving process is costly, and often doubles the price of the fibre material.

### SUMMARY OF INVENTION

For achieving high strength, an increased number of unidirectional fibre layers are typically placed in the mould. This requires much labour force, and leads to high cost of the final product.

A method for manufacturing a bundle of roving yarns, a bundle of roving yarns methods for manufacturing a work piece and a work piece are described. The method of manufacturing a bundle of roving yarns includes assembling a number of roving yarns of longitudinal unidirectional fibres and an additional component in the bundle. The longitudinal unidirectional fibres may, for example, be reinforced fibres. For example at least 10 roving yarns are assembled in a bundle. It is also possible that more roving yarns are assembled in a bundle such as 10 to 100. Roving yarns contain thousands of single fibres.

The fibre yarn may be supplied directly into the mould, or a machinery in the vicinity of the mould may be employed for assembling the roving yarns into bundles, that may be placed in the mould in a simple and fast way. Hence, the manufacturing of bundles of roving yarns simplifies the placing of unidirectional fibre material in a mould, for example for manufacturing a wind turbine blade. The bundles may easily be placed in the mould, for example by a robot.

Providing and using longitudinal unidirectional fibres assembled in bundles of 10 to 100 or more roving yarns allows that they may replace woven fabrics, which are typically more expensive than the described bundles of roving yarns. The method of manufacturing bundles of roving yarns provides a cost reducing material which may be used for manufacturing work pieces.

At least one resin distribution means or a thermoplastic material may be placed as additional component in the bundle. Generally, the additional component may be placed in the centre of the bundle. The resin distribution means may for example be a flow enhancing means or a resin transport means, which accommodates the resin flow for the impregnation of the fibres in the surrounding rovings. The resin distribution means or flow enhancing means or a resin transport means may have a higher permeability for liquid resin flow than the longitudinal unidirectional fibres.

In the context of the method of manufacturing a bundle of roving yarns at least one porous yarn and/or at least one fibrous yarn and/or at least one permeable tube and/or at least one resin flow channel may be placed as resin distribution means in the bundle. The additional component may be placed in the middle or in the centre of the roving bundle. The centrally located additional component serves as a fast resin transport channel, in order to reach a fast impregnation of the roving fibres. By means of vacuum and capillary forces the resin may migrate from the centre to the surrounding rovings. As a porous yarn is placed in the centre, there are equal distances to the outmost fibres of the bundle. Instead of a porous yarn, a permeable tube of plastic, paper, or other material could be used.

The resin flow channel in the centre of the roving bundle may be constructed in a way that allows the resin to be drained from the channel by means of capillary forces from the roving area. Either the empty channel space may then be a porous structure, resembling a sandwich foam material, or the channel may be made collapsible. The collapse may for example be initiated by elevated temperatures, a higher vacuum level or other controlled physical changes.

Moreover, at least one thermoplastic fibre and/or at least one thermoplastic sheet may be placed in the bundle as thermoplastic material. The use of thermoplastic material provides the possibility of thermosetting the bundle, for example in the context of a process for manufacturing a work piece.

Generally, glass fibres, carbon fibres, basalt fibres, aramid fibres or natural fibres, for example natural fibres from wood or plants, may be used as roving yarns.

The bundle of roving yarns may be wrapped by a wrapping yarn. The wrapping yarn may be coiled around the bundle. The wrapping yarn may be an elastic yarn. Using an elastic yarn allows the bundle to change its round shape when placed in a mould, so that all bundles fit with no air voids between the bundles. Furthermore, the bundles may be stored on a bobbin and than used later, or the bundles may be transferred directly from a winding machine to a mould. Alternatively, yarns that are not elastic may also be foreseen.

The used roving yarn and/or the used wrapping yarn may comprise randomly oriented fibres or transverse fibres. The randomly oriented fibres or transverse fibres may for example be milled fibres, short fibres or long fibres. They may be placed on the outside of the bundle or in the outmost layer of the roving or may be included in the bundle or attached to the bundle. The use of randomly oriented fibres or longitudinal fibres enhances the shear strength of a laminate to be created via the bundles. Another purpose of these randomly oriented fibres is to improve the crack resistance in these unidirectional fibre laminates. Randomly oriented short or long fibres may also be integrated in or placed on the resin yarn that holds the roving bundle together.

The bundle of roving yarn comprises a number of roving yarns of longitudinal unidirectional fibres and an additional component. Generally, the bundle of roving yarn may be manufactured by the previously described method. For example, the bundle of roving yarn may comprise at least one resin distribution means or a thermoplastic material as the additional component. Moreover, it may comprise at least one porous yarn and/or fibrous yarn and/or permeable tube and/or resin flow channel as resin distribution means. Furthermore, it may comprise at least one thermoplastic fibre and/or thermoplastic sheet as thermoplastic material.

The bundle of roving yarn may comprises at least one wrapping yarn, which may be coiled around a bundle.

Furthermore, the roving yarn may comprise randomly oriented fibres or transverse fibres. The wrapping yarn may also comprise randomly oriented fibres or transverse fibres.

Regarding further properties and advantages of the bundles of roving yarn it is referred to the previously described method.

The method for manufacturing a work piece by vacuum assisted resin transfer moulding comprises the steps of placing at least one bundle of roving yarn as previously described in a mould of a closed mould system, applying vacuum to the closed mould system and injecting resin into a mould cavity. The work piece may, for example, be a wind turbine rotor blade. The bundles of roving yarn may be transferred directly from a winding machine into the mould. Generally, the bundles may be placed in the mould by means of a robot. After placing the bundles in the mould, the at least one bundle of roving yarn or the number of roving yarn bundles may be compacted. This may be performed by means of vacuum.

An alternative method for manufacturing a work piece comprises the steps of placing at least one previously described bundle of roving yarn which comprises thermoplastic material in a mould and thermosetting the thermoplastic material. The thermosetting is performed by consolidating the material by initial heating and melting the thermoplastic material, followed by cooling the material In order to melt the thermoplastic material, the thermoplastic fibres mixed with reinforcement fibres may be heated, to for example 200° C. Then, the liquid thermoplastic material may flow in between the reinforced fibres, for example under vacuum. When cooled and solidified, the work piece is finished. This method provides a cheap and easily performable method for manufacturing a longitudinal unidirectional fibre material.

The work piece is manufactured by one of the previously described methods. The work piece may be manufactured at comparably low costs since expensive woven fibre material may be replaced by bundles of roving yarn.

A fast production rate may be obtained with bundles instead of single roving laid in the mould. Moreover, an improved linear fibre orientation is obtained as no stitching yarns are creating waviness or resin rich pockets. Furthermore, a faster impregnation of the fibres may be done, due to a proper combination of vacuum channels and capillary forces. Laminates with extremely high stiffness (E-Modulus) may be fabricated.

Further features, properties and advantages will become clear from the following description of embodiments in conduction with the companying drawings. The described features may be in any combination with each other.

### BRIEF DESCRIPTION OF THE DRAWINGS

Elements of the different figures and embodiment which correspond to each other are designated with the same reference numeral.

FIG. 1 schematically shows the method for manufacturing a bundle of roving yarns.

FIG. 2 schematically shows a bundle of roving yarns in a sectional view.

FIG. 3 schematically shows an assembly of a number of bundles of roving yarns in a sectional view.

FIG. 4 schematically shows the assembly of FIG. 3 after applying vacuum.

FIG. 5 schematically shows a coiled bundle of roving yarns.

FIG. 6 schematically shows the placement of roving bundles in a mould.

FIG. 7 schematically shows a further variant of a wrapped roving bundle in a sectional view.

FIG. 8 schematically shows the wrapped roving bundle of FIG. 7 in a side view.

FIG. 9 schematically shows the wrapped roving bundle of FIG. 7 in a perspective view.

FIG. 10 schematically shows an wrapped bundle in a perspective view.

FIG. 11 schematically shows only the wrapping yarn of FIG. 10.

FIG. 12 schematically shows a bundle of rovings in a sectional view.

FIG. 13 schematically shows a further variant of a bundle of rovings in sectional view.

FIG. 14 schematically shows another variant of a bundle of rovings in sectional view.

### DETAILED DESCRIPTION OF INVENTION

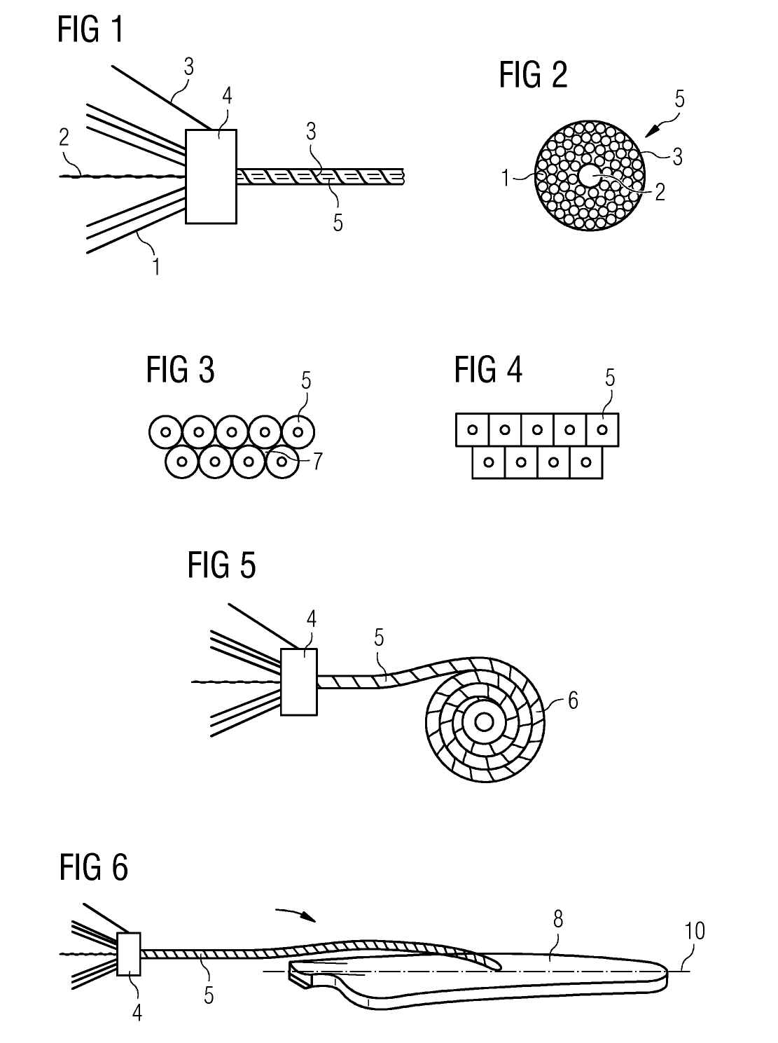

A first embodiment will now be described with reference to FIGS. 1 to 6. FIG. 1 schematically shows the method for manufacturing a bundle of roving yarns. A number of roving yarns 1 and a central resin flow yarn 2 are assembled in a bundle of rovings 5 by means of a winding apparatus 4. An additional wrapping yarn 3 is circumferentially winded about the bundle of rovings 5 by means of the winding apparatus 4.

The roving yarn 1 may comprise glass fibre, carbon fibre, basalt fibre, aramid fibre or nature fibre, for example from wood or plants. The roving yarn 1 comprises longitudinal unidirectional reinforced fibres. The bundle 5 may comprises at least 10 roving yarns 1. However, more roving yarns 1 such as 10 to 100 roving yarns 1 may be used. The wrapping yarn 3 may be an elastic yarn. This allows the bundle 5 to change its round shape when placed in a mold, so that all bundles 5 fit with no air voids between the bundles. Yarns 3 that are not elastic may although be foreseen.

The centrally placed flow yarn 2 may for example be a porous or fibrous yarn. It may be placed in a middle of the roving bundle 5. The central yarn serves as a fast resin transport channel, in order to reach a fast impregnation of the roving fibres 1. By means of vacuum and capillary forces the resin will migrate from the centre to the surrounding roving. As the porous yarn is placed in the centre, there are equal distances to the outmost fibres 1 of the bundles 5. Instead of a porous yarn, a permeable tube of plastic, paper, or other material may be used.

FIG. 2 schematically shows a bundle of roving yarns in a sectional view. The bundle 5 has a round shape. The resin transport yarn or tube 2 is located in the center of the bundle 5 and is surrounded by a number of unidirectional roving yarns 1.

FIG. 3 schematically shows an assembly of a number of bundles of roving yarns 5, for example in a mould for manufacturing a work piece like a wind turbine rotor blade. FIG. 3 shows the bundles 5 in a sectional view. Between the bundles 5 which are touching each other, air voids 7 are occurring.

FIG. 4 schematically shows the assembly of FIG. 3 after applying vacuum during a process of vacuum applied present transfer molding. In FIG. 4 the roving bundles 5 are compacted by applying vacuum, for example in a closed mould system. The air voids 7 between the bundles 5 are no longer present.

FIG. 5 schematically shows a coiled bundle of roving yarns. After manufacturing a bundle of roving yarns 5 by means of a winding apparatus 4 as previously described in conjunction with FIG. 1, the wrapped bundle of roving 5 is coiled. The coiled bundle is designated by reference numeral 6. A coiling of the bundle of roving yarns 5 is especially possible, if an elastic wrapping yarn 3 is used.

FIG. 6 schematically shows the placement of roving bundles 5 in a mould 8. In FIG. 6 a mould 8 for manufacturing a wind turbine rotor blade is shown. A number of wrapped roving bundles 5, as previously described, are assembled in the mould. The wrapped roving bundles 5 may be assembled in longitudinal direction or parallel to the span direction of the wind turbine rotor blade.

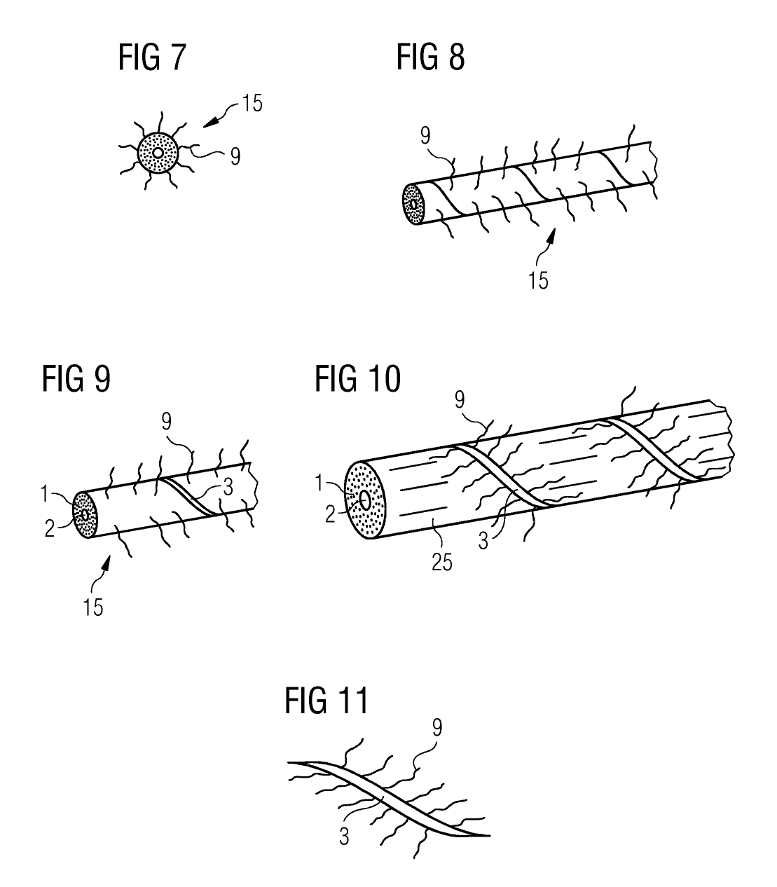

A further variant of the wrapped roving bundle will now be described with reference to FIGS. 7 to 9. FIG. 7 schematically shows a wrapped roving bundle 15 in a sectional view. FIG. 8 schematically shows the wrapped roving bundle 15 in a side view and FIG. 9 schematically shows the wrapped roving bundle 15 in a perspective view.

The wrapped roving bundle 15 comprises unidirectional roving 1, a central resin flow channel 2 and a number of transverse fibres 9. For example, only on the outside of the bundle 15 or in the outmost layers of roving 1 the transverse or randomly oriented fibres 9 are present. The transverse or randomly oriented fibres 9 may, for example, milled fibres, short fibres or long fibres. They may be included or attached to the bundle 15, in order to enhance the shear strength of the laminate to be created. Another purpose of these randomly oriented fibres 9 may be to improve crack resistance in these unidirectional fibre laminates.

A variant which may be applied to all embodiments will now be described with reference to FIGS. 10 and 11. Randomly oriented short or long fibres may be integrated in or placed on the wrapping yarn 3 that holds the roving bundle 5 or 15 together. This is schematically shown in FIG. 10 and FIG. 11. FIG. 10 schematically shows an wrapped bundle 25 in a perspective view. FIG. 11 schematically shows only the wrapping yarn 3 of FIG. 10.

The bundle 25 may have the properties of the bundle 5, which was previously described in FIGS. 1 and 2 or may have the properties of the bundle 15, which was previously described with reference to FIGS. 7 to 9. The bundle 25 in FIG. 10 comprises a wrapping yarn 3 which comprises transverse or randomly oriented fibres 9. The transverse or randomly oriented fibres 9, which may for example be milled fibres, short fibres or long fibres, enhance the shear strength of a laminate to be created. Moreover, the transverse or randomly oriented fibres 9 may improve the crack resistance system of the created fibres laminate.

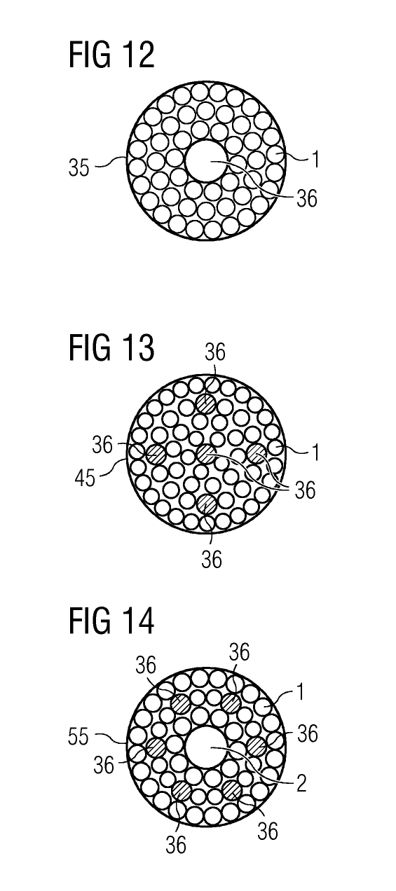

A further embodiment will now be describes with reference to FIGS. 12 to 14. FIG. 12 schematically shows a bundle of rovings 35 in a sectional view. The bundle comprises a number of roving yarns 1 and a thermoplastic fibre 36. The thermoplastic fibre 36 is located in the center of bundle 35.

FIG. 13 schematically shows a further variant of a bundle of rovings 45 in sectional view. The bundle 45 comprises a number of roving yarn 1 and a number of thermoplastic fibres 36. In the bundle 35 the thermoplastic fibres 36 are randomly placed between the roving yarns 1.

FIG. 14 schematically shows another variant of a bundle of rovings 55 in sectional view. The bundle of rovings 55 comprises a number of roving yarns 1, a number of thermoplastic fibres 36 and a resin transport yarn 2. The resin transport yarn 2 or resin distribution means 2 is placed in the center of the bundle 55. The resin distribution means 2 may have the properties as previously described. The thermoplastic fibres 36 are randomly placed between the roving yarns 1.

The method for manufacturing a bundle of roving yarns may also be used for a mixture of reinforced fibres 1 and thermoplastic fibres 36, thermoplastic sheets, or thermoplastic materials in general as, for example, shown in FIGS. 12 to 14. For manufacturing a work piece, for example a wind turbine rotor blade, the bundles 35, 45 and 55, as shown in FIGS. 12 to 14, may be placed in a mould. The thermoplastic fibre material 36, mixed with reinforced fibre material 1, may then be melted and cured. In order to melt the thermoplastic material, the thermoplastic fibres mixed with reinforcement fibres may be heated, to for example 200° C. Then, the liquid thermoplastic material may flow in between the reinforced fibres, for example under vacuum. When cooled and solidified, the work piece is finished.

Additionally to thermosetting the material, liquid resin may be infused into the fibre filled mold cavity of a closed mould system.

All previously described bundles of roving 5, 15, 25, 35, 45 and 55 may be used for manufacturing a work piece, for example a wind turbine rotor blade, by means of Vacuum Assisted Resin Transfer Moulding (VARTM). In this context fibre material, for example a number of unidirectional fibre layers and/or a number of bundles of roving 5, 15, 25, 35, 45 and 55, are placed in a mould shell. A mould core may be placed onto the fibre material. Then the mould may be closed and vacuum may be applied to the closed mould cavity. Then, resin, such as polyester resin, epoxy resin, vinyl ester or other resin, may be injected into the mould cavity, filing the space between the fibres in the laminate.

Alternatively or additionally, thermoplastic material may be mixed with the fibre reinforced material or may be placed between fibre layers. In this case, the thermoplastic material may be heated and melted. Then, the mixture between thermoplastic fibres and reinforced fibre material is consolidated by initial heating and melting the thermoplastic material, followed by the solidification by cooling the material. Then, the mixture between thermoplastic fibres and reinforcement fibre material is forming a rigid composite material.

1. A method of manufacturing a bundle of roving yarns, comprising:
assembling a plurality of roving yarns of longitudinal unidirectional fibres and an additional component in a bundle.

2. The method as claimed in claim 1,
wherein a at least one resin distribution means or thermoplastic material is the additional component.

3. The method as claimed in claim 2,
wherein the resin distribution means is a porous yarn, a fibrous yarn, a permeable tube or a resin flow channel.

4. The method as claimed in claim 2,
wherein the thermoplastic material is a thermoplastic fibre or a thermoplastic sheet.

5. The method as claimed in claim 1,
wherein the roving yarns are glass fibres, carbon fibres, basalt fibres, aramid fibres or natural fibres as roving yarns.

6. The method as claimed in claim 5,
wherein the roving yarns include randomly oriented fibres or transverse fibres.

7. The method as claimed in claim 1, comprising:
wrapping the bundle of roving yarn by a wrapping yarn.

8. The method as claimed in claim 7, comprising:
wherein the wrapping yarn includes randomly oriented fibres or transverse fibres.

9. A bundle of roving yarn, comprising:
a plurality of roving yarns of longitudinal unidirectional fibres and an additional component.

10. The bundle of roving yarn as claimed in claim 9,
wherein the additional component comprises at least a resin distribution means or a thermoplastic material.

11. The bundle of roving yarn as claimed in claim 10,
wherein the resin distribution means is a porous yarn, a fibrous yarn, a permeable tube or a resin flow channel.

12. The bundle of roving yarn as claimed in claim 10,
wherein the thermoplastic material is a thermoplastic fibre or a thermoplastic sheet.

13. The bundle of roving yarn as claimed in claim 10, comprising:
a wrapping yarn wrapped around the plurality of roving yarns.

14. The bundle of roving yarn as claimed in claim 10,
wherein the roving yarn comprises randomly oriented fibres or transverse fibres.

15. The bundle of roving yarn as claimed in claim 13,
wherein the wrapping yarn comprises randomly oriented fibres or transverse fibres.

16. A method for manufacturing a work piece by Vacuum Assisted Resin Transfer Moulding, comprising:
placing at least one bundle of roving yarn as claimed in claim 10 in a mould of a closed mould system; and
applying vacuum to the closed mould system and injecting resin into a mould cavity.
